(19) United States
(12) Patent Application Publication
(10) Pub. No.: US 2010/0316891 A1
(43) Pub. Date: Dec. 16, 2010

(54) SECONDARY BATTERY INCLUDING PROTECTION CIRCUIT MODULE

(75) Inventors: Youngcheol JANG, Suwon-si (KR); Eunok KWAK, Suwon-si (KR); Nohyun KWAG, Suwon-si (KR)

Correspondence Address: ROBERT E. BUSHNELL & LAW FIRM, 2029 K STREET NW, SUITE 600, WASHINGTON, DC, 20006-1004, US

(73) Assignee: SAMSUNG SDI CO., LTD.,, Suwon-si (KR)

(21) Appl. No.: 12/750,314

(22) Filed: Mar. 30, 2010

(30) Foreign Application Priority Data
Jun. 15, 2009 (KR) 10-2009-0053017

(51) Int. Cl. H01M 6/02

(52) U.S. Cl. 429/7

(57) ABSTRACT

A secondary battery including a bare cell, a protection circuit module provided with a circuit board, and a coupling member adapted to connect the bare cell to the protection circuit module. The coupling member has a bare cell coupling portion coupled to the bare cell, first and second circuit board coupling portions coupled to the circuit board, and first and second connecting portions connecting the bare cell coupling portions to the first and second circuit board coupling portions, respectively. The first and second connecting portions are inclined against a normal, or perpendicular, with respect to the bare cell coupling portion

### CLAIM OF PRIORITY

This application makes reference to, incorporates the same herein, and claims all benefits accruing under 35 U.S.C. §119 from an application earlier filed in the Korean Intellectual Property Office on Jun. 15, 2009 and there duly assigned. Serial No. 1.0-2009-0053017.

### BACKGROUND OF THE INVENTION

1. Field of the Invention

An aspect of the present invention relates to a secondary battery, and more particularly, to a secondary battery including a protection circuit module.

2. Description of the Related Art

Recent rapid advances in the electronics, communications and computer industries have increased the use of portable electronic devices. Most of such portable electronic devices employ rechargeable secondary batteries as power sources.

Secondary batteries are widely used at present in the form of packs. A typical secondary battery pack has a structure in which a bare cell serving as an electrical energy source and a protection circuit module (PCM) adapted to stably control the charging/discharging of the bare cell are combined into one unit.

The bare cell and the protection circuit module can be coupled to each other in various configurations. An externally applied impact may damage the coupling between the bare cell and the protection circuit module, which may result in the separation of the hare cell and the protection circuit module. Thus, there is a need for a coupling structure that can increase the bonding strength between the bare cell and the protection circuit module.

### SUMMARY OF THE INVENTION

An aspect of the present invention provides a secondary battery which includes a bare cell; a protection circuit module provided with a circuit board; and a coupling member having a bare cell coupling portion coupled to the bare cell, first and second circuit hoard coupling portions coupled to the circuit board, and first and second connecting portions respectively connecting the bare cell coupling portion to the first and second circuit board coupling portions, wherein the first and second connecting portions are inclined with respect to the bare cell coupling portion.

The bare cell coupling portion may have a first end portion that is connected to the first connecting portion and is positioned on the first circuit board coupling portion when being projected in a direction perpendicular to the bare cell coupling portion, and a second end portion that is connected to the second connecting portion and is positioned on the second circuit board coupling portion when being projected in a direction perpendicular to the bare cell coupling portion. The first end portion may be positioned farther away from the center of the bare cell coupling portion than a third end portion at which the first connecting portion is connected to the first circuit board coupling portion; and the second end portion may be positioned farther away from the center of the bare cell coupling portion than a fourth end portion at which the second connecting portion is connected to the second circuit board coupling portion. The distance between the first end portion and the second end portion may be larger than the distance between the third end portion and the fourth end portion.

The first connecting portion may be inclined with respect to the first circuit board coupling portion and the second connecting portion may be inclined with respect to the second circuit board coupling portion.

The bare cell coupling portion, the first connecting portion and the first circuit board coupling portion may be arranged in one substantially zigzag Z-shaped configuration; and the bare cell coupling portion, the second connecting portion and the second circuit board coupling portion may be arranged in a mirror-image substantially zigzag Z-shaped configuration.

The coupling member may be formed by bending an unitary, one-piece plate member,

The coupling member may be made of a conductive material. The coupling member may be made of nickel.

The bare cell coupling portion may be coupled to a first electrode terminal of the bare cell, and the first and second circuit board coupling portions may be respectively coupled to first and second coupling pads formed in the circuit board.

The circuit board may have a through-hole and the bare cell coupling portion may be disposed at a position corresponding to the through-hole. The first and second circuit board coupling portions may be respectively coupled to the first and second coupling pads around both sides of the through-hole of the circuit board.

The first circuit board coupling portion may overlap the bare cell coupling portion when being projected in a direction perpendicular to the bare cell coupling portion. The second circuit board coupling portion may overlap the bare cell coupling portion when being projected in a direction perpendicular to the bare cell coupling portion.

Additional aspects and/or advantages of the invention will be set forth in part in the description which follows and, in part, will be readily appreciated from these details set forth in the description, or may be learned by practice of the invention.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a secondary battery constructed according to an embodiment of the present invention;

FIG. 2 is an exploded perspective view illustrating the secondary battery of FIG. 1;

FIG. 3 is a front view illustrating the secondary battery of FIG. 2 from which the top case and the label are removed;

FIG. 4 is a side view, taken along sectional line IV-IV′ of FIG. 3, for the protection circuit module of the secondary battery; and

FIG. 5 is a perspective view illustrating the coupling member for the secondary battery of FIG. 4.

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

Here, when one element is referred to as being connected to another element, one element may be not only directly connected to the another element but instead may be indirectly connected to the another element via one or more other elements. Also, when an element is referred to as being “on” another element, it can be directly on the another element or be indirectly on the another element with one or more intervening elements interposed 17 therebetween. Further, some of the elements that are not essential to the complete description of the invention have been omitted for clarity. In addition, like reference numerals refer to like elements throughout.

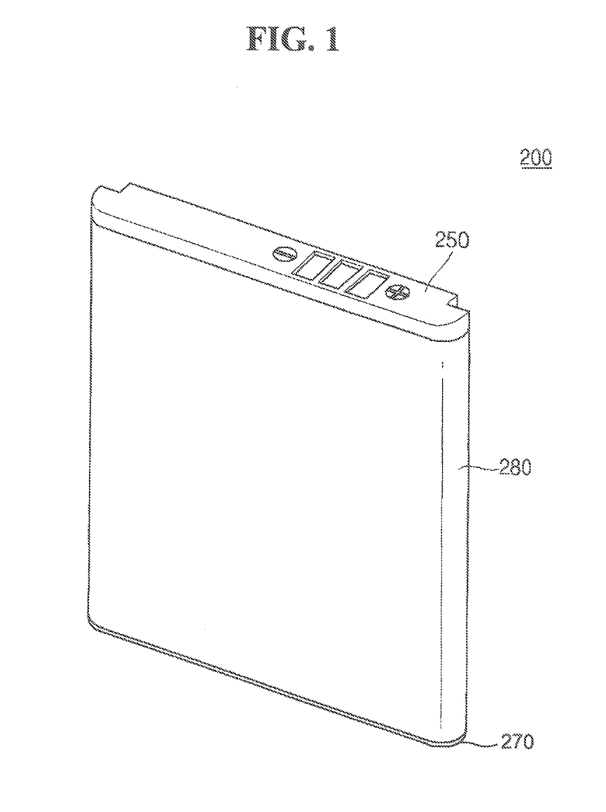

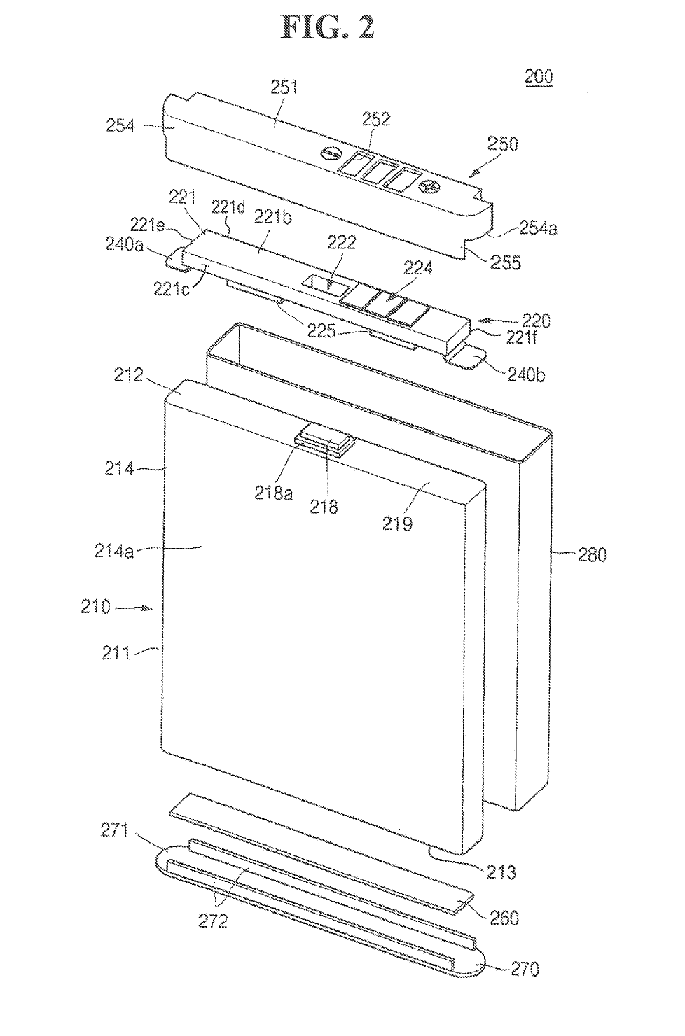

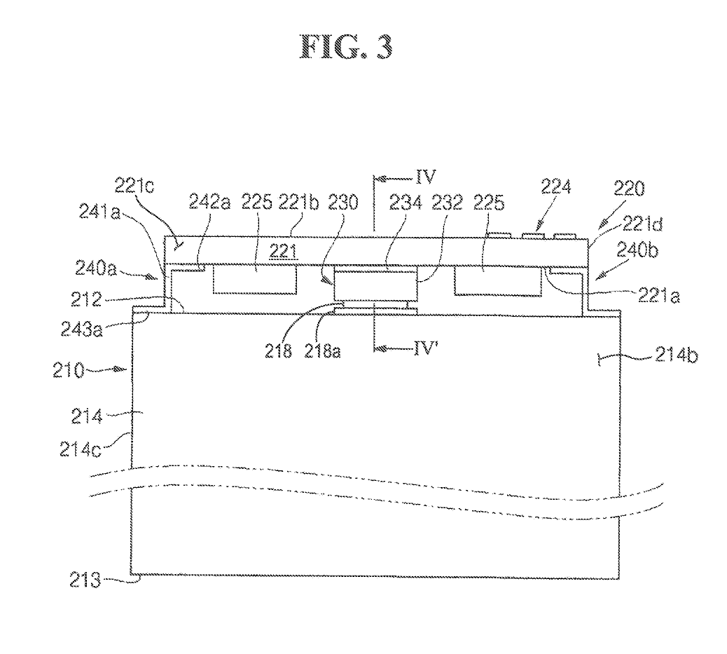

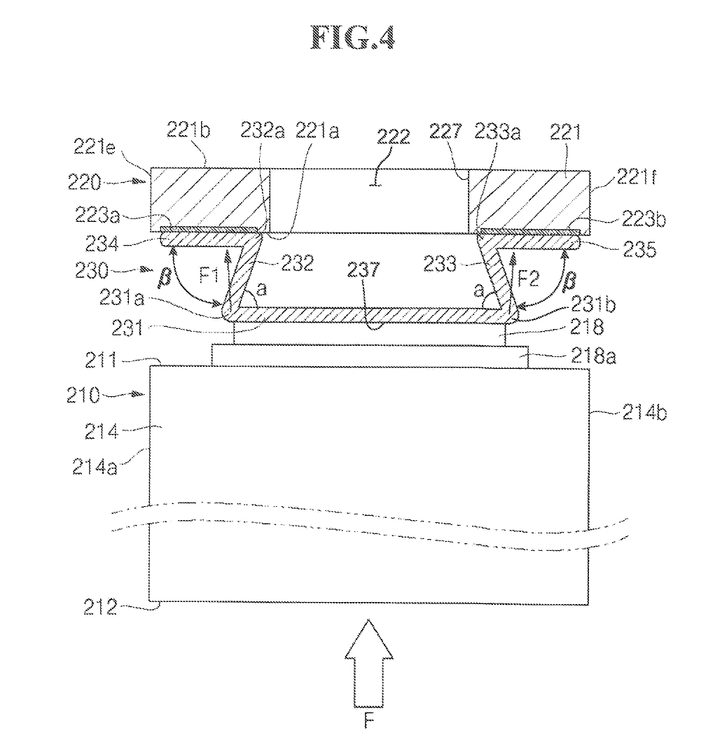

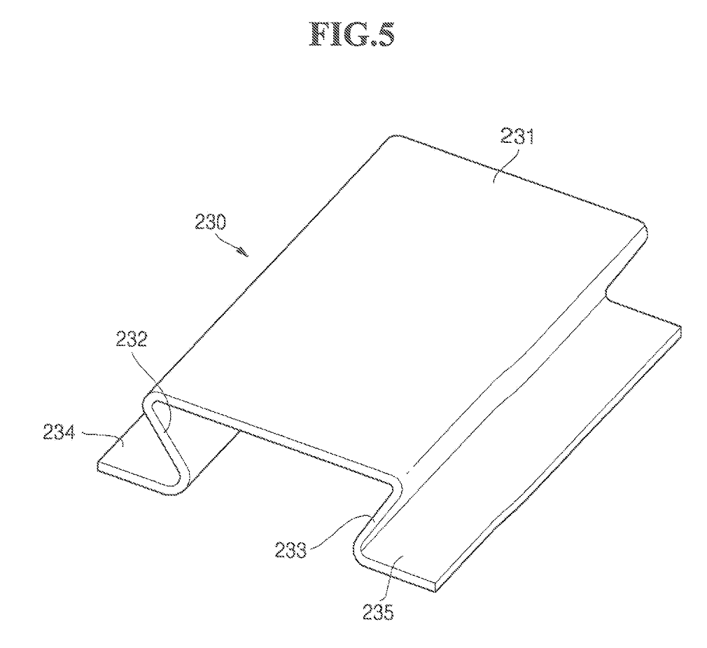

FIG. 1 is a perspective view of a secondary battery as an embodiment of the present invention, FIG. 2 is an exploded perspective view illustrating the secondary battery, FIG. 3 is a front view illustrating the secondary battery from which the top case and the label are removed, FIG. 4 is a side view of the protection circuit module, taken along sectional line IV-IV′ of FIG. 3, for the protection circuit module of the secondary battery, and FIG. 5 is a perspective view illustrating the coupling member of the secondary battery of FIG. 4.

Referring to FIGS. 1 through 4, the secondary battery 200 includes a bare cell 210, a protection circuit module 220, a coupling member 230, and first and second support members 240a and 240b. The secondary battery 200 may further include a top case 250, an adhesive member 260, a bottom case 270, and a label 280.

The bare cell 210 serves as an electrical energy source. The bare cell 210 includes an electrode assembly (not shown), a can 211 adapted to accommodate the electrode assembly therein as a receptacle, has an open upper end, and a cap assembly 212 adapted to close the open upper end of the can 211.

The electrode assembly (not shown) is constructed by winding a laminate of a positive electrode plate, a negative electrode plate and a separator interposed between the two electrode plates (also not shown). Positive and negative electrode tabs (not shown) are respectively coupled to the positive and negative electrode plates.

The can 211 includes a bottom plate 213 and side walls 214 extending upward from the edges of the bottom plate 213. The side walls 214 consist of long side walls 214a and 214b formed opposite to and spaced-apart from each other and short side walls 214c and 214d formed opposite to and spaced-apart from each other. The long side walls 214a and 214b each define provide major surfaces that have greater widths than the minor surfaces provided by short side walls 214c and 214d.

A first electrode terminal 218 suitable for use as a negative terminal, protrudes from the cap assembly 212. The entire outer surface of bare cell 110, except the first electrode terminal 218 forms a second electrode terminal 219 which may serve as a positive terminal. An insulating gasket 218a surrounds first electrode terminal 218 in order to electrically insulate the first electrode terminal 218 from second electrode terminal 219. In this embodiment, first and second electrode terminals 218, 219 respectively function as negative and positive terminals. It will be appreciated by those skilled in the art that the first and second electrode terminals 218 and 219 can function as positive and negative terminals, respectively, depending upon their connection to the electrode plates of the electrode assembly (not shown).

Cap assembly 212 can be joined to can 211 by resistance welding or alternatively, by laser welding.

Protection circuit module (PCM) 220 includes a circuit board 221 and electrical circuit devices 225 mounted on the circuit board 221. The protection circuit module 220 controls various operations (including charge/discharge operations) of secondary battery 200. A through hole 222 with side walls 227, perforates protection circuit module 220. A through hole 222 with side walls 227, perforates protection circuit module 220.

Circuit board 221 is a printed circuit board having an interconnection pattern of electrical conductors printed thereon. The circuit board 221 has an elongated shape conforming in size and dimensions to cap assembly 212 of bare cell 210. The circuit board 221 is substantially rectangular in shape, and has two long sides 221c and 221d and two short sides 221e and 221f. The circuit board 221 has a through-hole 222 providing access to coupling member 230 which is connected to the first electrode terminal 218 of the bare cell 210. Through-hole 222 is formed at a position corresponding to the first electrode terminal 218 of the bare cell 210. For example, welding may be used to join the coupling member 230 to the first electrode terminal 218 of the bare cell 210 through the through-hole 222.

The circuit board 221 has a first surface 221a and a second surface 221b opposite to and spaced-apart from the first surface 221; first and second surfaces 221a, 221b being spaced-apart by the thickness of circuit board 221. The first surface 221a of the circuit board 221 is spaced apart and separated from, and faces the cap assembly 212. A first conductive coupling pad 223a and a second conductive coupling pad 223b are disposed at the first surface 221a to couple the circuit board 221 to the coupling member 230 therethrough. The first coupling pad 223a and the second coupling pad 223b are disposed along the two long sides 221c and 221d respectively, on laterally opposite sides of through-hole 222. The first coupling pad 223a and the second coupling pad 223a are electrically connected to an interconnection pattern born on the circuit hoard 221. The two coupling pads 223a and 223b may be formed simultaneously when the interconnection pattern of the circuit board 221 is formed or alternatively, may be formed in a separate step after the formation of the interconnection pattern. Outer terminals 224 are disposed on the second surface 221b of the circuit board 221. The outer terminals 224 are electrically connected to an external load or a charger.

The electrical circuit devices 225 are mounted on the first surface 221a of the circuit board 221. The electrical circuit devices 121g include a control IC, a charge/discharge switch, a thermal fuse, such as a positive temperature coefficient (PTC) thermistor, or other thermally reactive device.

Referring to FIGS. 4 and 5, the coupling member 230 is formed by bending a one-piece plate member, and includes a bare cell coupling portion 231 positioned between first and second circuit hoard coupling portions 234 and 235, and first and second connecting portions 232 and 233. Coupling member 230 is made of an electrically conductive material such as nickel. Coupling member 230 structurally couples and electrically connects bare cell 210 to protection circuit module 220.

The bare cell coupling portion 231 is in the form of a flat plate and is disposed at a position corresponding to the through-hole 222 of the circuit board 221. The bare cell coupling portion 231 is structurally coupled and electrically connected to the first electrode terminal 218 of the bare cell 210 by an appropriate bonding technique (e.g., welding) through the through-hole 222 of the circuit board 221. The bare cell coupling portion 231 is spaced a part by a certain distance from the first and second circuit board coupling portions 234 and 235.

The first and second circuit board coupling portions 234 and 235 are respectively coupled to bare cell coupling portion 231 by the two coupling pads 223a and 223b of the circuit board 221. The first connecting portion 232 connects hare cell coupling portion 231 to first circuit board coupling portion 234. The second connecting portion 233 connects the hare cell coupling portion 231 to the second circuit board coupling portion 235.

The first circuit board coupling portion 234 is structurally coupled and electrically connected to the first coupling pad 223a that forms part of one distal end of the circuit board 221.

The second circuit board coupling portion 235 is structurally coupled and electrically connected to the second coupling pad 223b that forms part of one distal end of the circuit board 221.

The first connecting portion 232 and the second connecting portion 233 form diagonal structure members that electrically connect the bare cell coupling portion 231 to the first circuit board coupling portion 234 and the second circuit board coupling portion 235, respectively. The bare cell coupling portion 231, first and second circuit board coupling portions 234 and 235 are spaced apart from one another and held in a rigid formation by first connecting portion 232. The first and second connecting portions 232 and 233 are disposed at acute angles a with respect to the bare cell coupling portion 231. The angles a are less than 90° but preferably greater than 45°. A first end portion 231a is formed at a position where the bare cell coupling portion 231 and the first connecting portion 232 meet together, and a second end portion 231b is formed at a position where the bare cell coupling portion 231 and the second connecting portion 233 meet together. A third end portion 232a is formed at a junction created at a position where the first connecting portion 232 and the first circuit board coupling portion 234 meet together to form an acute included angle B. A fourth end portion 233a is formed at a junction created at a position where the second connecting portion 233 and the second circuit board coupling portion 235 meet together to form an acute included angle B. The first end portion 231a is positioned farther away from the center of the bare cell coupling portion 231 than the third end portion 232a; this offset between first end portion 231a and third end portion 232s allows a greater length, and thus surface area, of first circuit board coupling portion 231 available to mate with the first surface 221a of circuit board 221 at first conductive coupling pad 223a. The second end portion 231b is positioned farther away from the center of the bare cell coupling portion 231 than the fourth end portion 233a; this offset between second and portion 231b and fourth end portion 233a allows a greater length, and thus surface area, of second circuit board coupling portion 235 available to mate with the first surface 221a of circuit board 221 at first conductive coupling pad 223b. Due to the inclination of the first connecting portion 232, the first circuit board coupling portion 234 casts a shadow that overlaps the bare cell coupling portion 231 when being projected in a direction parallel to the bare cell coupling portion 231.

The second connecting portion 233 connects the bare cell coupling portion 231 and the second circuit board coupling portion 235, which are held spaced apart from each other in a rigid formation by second connection portion 233. The second connecting portion 233 is disposed at an acute angle a with respect to the bare cell coupling portion 231. The angle a is less than 90° but preferably greater than 45°. With this configuration, the second end portion 231b, which forms the junction where the second connecting portion 233 is connected to the second circuit board coupling portion 235. Second circuit board coupling portion 235 is positioned farther away from the center of the bare cell coupling portion 231 than the fourth end portion 233a. Fourth end portion 233a forms another junction where the second connecting portion 233 is connected to the second circuit board coupling portion 235. Due to the inclination of the second connecting portion 233, the second circuit board coupling portion 235 casts a shadow that overlaps the bare cell coupling portion 231 when being projected in a direction parallel to the bare cell coupling portion 231.

The bare cell coupling portion 231, the first connecting portion 232 and the first circuit board coupling portion 234 are arranged in a substantially zigzag Z-shaped configuration, and the bare cell coupling portion 231, and the second connecting portion 233 and the second circuit board coupling portion 235 may be arranged in a mirror-image and longitudinally opposite, substantially zigzag Z-shaped configuration. Due to these characteristic configurations, the direction of a force F caused by an external impact transmitted to the coupling member 230 is distributed as weaker forces F1, F2 in order to improve the bonding strength between the circuit to board 221 and the coupling member 230, which will be explained in detail later. Further, the bare cell coupling portion 231 and the first and second circuit board coupling portions 234 and 235 of the coupling member 230 may be enlarged (e.g., as with enlarged surface areas) to achieve a further increase in bonding strength between the coupling member 230 and the circuit board 221.

Referring once again to FIGS. 2 and 3, the first support member 240a and the second support member 240b are respective positioned at both of the opposite distal ends 221e and 221f of circuit board 221. The first support member 240a is a plate-like member, and includes an intermediate support portion 241a joined at its opposite ends to a bare cell coupling portion 242a and a first circuit board coupling portion 243a. The bare cell coupling portion 242a is connected to the upper end of support portion 241a. The first circuit board coupling portion 243a is connected to the longitudinally opposite lower end of the support portion 241a. The coupling portions 242a and 243a are connected at right angles to and on opposite sides of support portion 241a and extend in directions opposite to each other away from support portion 241a. The bare cell coupling portion 242a is coupled to one distal end of the first surface 221a of the circuit board 221. The first circuit board coupling portion 243a is spaced apart from circuit board 221 and from coupling portion 242a. The first circuit board coupling portion 243a is connected to the upper surface 212 of the bare cell 210 by a suitable bonding technique, such as welding. The second support member 240b is structurally identical to the first support member 240a and is attached to, and thus a detailed explanation thereof is omitted.

Coupling member 230 is an electrical conductor constructed with bare cell coupling portion 231 that is electrically coupled to first electrical terminal 218 of bare cell 210, and to electrically conductive first and second circuit board coupling portions 234, 235, respectively, that extend along the oppositely oriented diagonal structural members formed by first and second coupling portions 232, 233, respectively. First and second coupling portions 232, 233 provide structural and electrical continuity between bare cell coupling portion 231 and corresponding first and second circuit hoard coupling portions 234, 235, respectively.

First and second coupling portions 232, 233 extend laterally outwardly from opposite ends of first and second coupling portions 232, 233, while the other opposite end portions 231a, 231b join the outermost opposite distal ends of bare cell coupling portions 231. Consequently, first and second circuit board coupling portions 234, 235, respectively are spaced-apart on opposite lateral sides of the side walls 227 of through hole 222, while electrically embracing first and second coupling pads 223a, 223b of protective circuit module 220.

Coupling member 230 provides continuous electrical continuity extending between first and second circuit board coupling portions 234, 235 and through the bare cell coupling portion 231, may be constructed as a single monolithic structure.

The first end portion 231a is positioned farther away from a center of bare cell coupling portion 231 than a third end portion forming a junction where the diagonally oriented first connecting portion 232 is connected to first circuit board coupling portion 234, and second end portion 231b is positioned farther away from the center of the bare cell coupling portion 231 than a fourth end portion forming a junction where the oppositely diagonally oriented second connecting portion 233 is connected to the second circuit board coupling portion 235.

The circuit board 221 is supported on the upper surface of cap assembly 212 of hare cell 210 by first and second support members 240a and 240b which extend longitudinally outwardly from beneath longitudinally opposite ends of protection circuit module 220. At least one of the two support members 240a and 240b is made of an electrically conductive material, which allows the support member to serve as an electrode lead plate that connects circuit board 221 to second electrode terminal 219 as a positive electrode of bare cell 210. In this embodiment, the electrode lead plate may be made of nickel. The material for the support member however, is not limited to nickel.

The top case 250 includes a cover plate 251 and a side wall 254 extending downward from cover plate 251.

Protection circuit module 220 is accommodated within an inner space of top case 250. Cover plate 251 has a shape substantially geometrically conforming to the corresponding topography and shape of cap plate 212 for bare cell 210. Cover plate 251 is provided with multiple through-holes 252. The outer terminals 224 of protection circuit module 220 are exposed to the outside world through corresponding ones of the through-holes 252. End portions 254a of side wall 254 are in contact with the upper surface 212 of the bare cell 210. An extension 255 extends from a portion of side wall 254 to extend downwardly from cover plate 251 to cover a portion of the side walls 214 of the bare cell 210.

The bottom case 270 includes a bottom plate 271 and two extensions 272 extending perpendicularly upward from bottom plate 271. Bottom plate 271 may have substantially the same shape as perpendicularly bottom plate 213 of the bare cell 210 and is attached to the bottom plate 213 of the bare cell 210 by means of adhesive member 260. The two extensions 272 extend longitudinally along bottom plate 271 to cover lower portions of the side walls 214 of the bare cell 210.

The label 280 is attached so as to surround the major surfaces separated by the plurality of minor exterior surfaces that form side walls 214 of the bare cell 210. The label 280 covers the extension 255 of top case 250 and extensions 272 of the bottom case 270.

Now, the function of this embodiment will be explained in detail.

Referring to again FIGS. 4 and 5, bare cell 210 is coupled to the protection circuit module 220 through the coupling member 230. Bare cell coupling portion 231 of the coupling member 230 is coupled to the first electrode terminal 218 of bare cell 210. The first circuit board coupling portion 234 of the coupling member 230 is coupled to the first coupling pad 223a of the circuit board 221. Second circuit board coupling portion 235 of the coupling member 230 is coupled to the second coupling pad 223b of circuit board 221. When a force F that accompanies an external impact to secondary battery 200, for example in a free fall test (FFT), is suddenly applied to the secondary battery 200, force F is divided by coupling member 230 into forces F1 and F2 which are transmitted toward first and second circuit board coupling portions 234 and 235 of coupling member 230, respectively. The forces F1 and F2 are transmitted in directions substantially perpendicular to the first circuit board coupling portion 234 and the second circuit board coupling portion 235, respectively, as indicated by arrows F1, F2. This force transmission is because the first end portion 231a, at which the bare cell coupling portion 231 is connected to the first connecting portion 232, is positioned on the first circuit board coupling portion 234 while being projected in a direction approximately perpendicular to hare cell coupling portion 231, and because second end portion 231b, at which the bare cell coupling portion 231 is connected to the second connecting portion 233, is positioned on the second circuit board coupling portion 235 when being projected in a direction that is approximately perpendicular to bare cell coupling portion 231. The forces F1 and F2, which are applied perpendicular to the first circuit board coupling portion 234 and the second circuit board coupling portion 235, respectively, do not react to the application of forces F1, F2 by functioning to separate coupling member 230 from circuit board 221. This therefore leads to improved bonding strength between circuit board 211 and coupling member 230.

As is apparent from the above description, the connecting portions of the coupling member adapted to connect the bare cell to the protection circuit module are formed obliquely. With this configuration, a force from an external impact is transmitted in a direction substantially perpendicular to the portions where the protection circuit module is coupled to the coupling member, leading to improved coupling between the bare cell and the protection circuit module.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A secondary battery comprising
a bare cell,
a protection circuit module provided with a circuit board, and
a coupling member having a hare cell coupling portion coupled to the bare cell, a first and second circuit board coupling portions coupled to the circuit board, and first and second connecting portions connecting the bare cell coupling portion to the first and second circuit board coupling portions, respectively,
wherein the first and second connecting portions are inclined to form acute included angles with respect to the bare cell coupling portion.

2. The secondary battery of claim 1, wherein the bare cell coupling portion has a first end portion that is connected to the first connecting portion and is positioned on the first circuit board coupling portion when being projected in a direction perpendicular to the bare cell coupling portion, and a second end portion that is connected to the second connecting portion and is positioned on the second circuit board coupling portion when being projected in a direction perpendicular to the bare cell coupling portion.

3. The secondary battery of claim 2, wherein:
the first end portion is positioned farther away from a center of the bare cell coupling portion than a third end portion at which the first connecting portion is connected to the first circuit board coupling portion; and
the second end portion is positioned farther away from the center of the bare cell coupling portion than a fourth end portion at which the second connecting portion is connected to the second circuit board coupling portion.

4. The secondary battery of claim 3, wherein a distance between the first end portion and the second end portion is larger than a distance between the third end portion and the fourth end portion.

5. The secondary battery of claim 1, wherein the first connecting portion is inclined with respect to the first circuit board coupling portion and the second connecting portion is inclined with respect to the second circuit board coupling portion.

6. The secondary battery of claim 1, wherein the bare cell coupling portion, the first connecting portion and the first circuit board coupling portion are arranged in a substantially zigzag Z-shaped configuration; and the bare cell coupling portion, the second connecting portion and the second circuit board coupling portion are arranged in a substantially zigzag Z-shaped configuration.

7. The secondary battery of claim 1, wherein the coupling member is formed by bending a one-piece plate member.

8. The secondary battery of claim, wherein the coupling member is made of a conductive material.

9. The secondary battery of claim, wherein the coupling member is made of nickel.

10. The secondary battery of claim 1, wherein the bare cell coupling portion is coupled to a first electrode terminal of the bare cell, and the first and second circuit board coupling portions are coupled to first and second coupling pads formed in the circuit board, respectively.

11. The secondary battery of claim 1, wherein the circuit board has a through-hole and the bare cell coupling portion is disposed at a position corresponding to the through-hole.

12. The secondary battery of claim 11, wherein the first and second circuit board coupling portions are coupled to the first and second coupling pads around both sides of the through-hole of the circuit board, respectively.

13. The secondary battery of claim 1, wherein the first circuit hoard coupling portion overlaps the bare cell coupling portion when being projected in a direction perpendicular to the bare cell coupling portion; and the second circuit hoard coupling portion overlaps the bare cell coupling portion when being projected in a direction perpendicular to the bare cell coupling portion.

14. A secondary battery according to claim 1, wherein the coupling member comprises a single monolithic structure providing continuous electrical continuity extending between the first and second circuit board coupling portions and through the bare cell coupling portion.

15. A secondary battery, comprising:
a bare cell;
a protection circuit module provided with a circuit board; and
an electrically conductive coupling member having a bare cell coupling portion electrically coupled to the bare cell, and having electrically conductive first and second circuit board coupling portions joined along oppositely oriented diagonals providing electrical continuity between the bare cell coupling portion and corresponding first and second circuit board coupling portions, the diagonals forming acute included angles with bare cell coupling portion.

16. A secondary battery according to claim 15, wherein the electrically conductive coupling member comprises a single monolithic structure providing continuous electrical continuity extending between first and second circuit board coupling portions and through the bare cell coupling portion.

17. The secondary battery of claim 15, wherein:
the first end portion is positioned farther away from a center of the bare cell coupling portion than a third end portion at which the first connecting portion is connected to the first circuit board coupling portion; and
the second end portion is positioned farther away from the center of the bare cell coupling portion than a fourth end portion at which the second connecting portion is connected to the second circuit board coupling portion.

18. The secondary battery of claim 17, wherein a distance between the first end portion and the second end portion is larger than a distance between the third end portion and the fourth end portion.

19. A secondary battery comprising:
a bare cell;
a protection circuit module provided with a circuit board; and
an electrical circuit coupling member having a bare cell coupling portion electrically coupled to the hare cell, and having electrically conductive first and second circuit board coupling portion extending along opposite diagonals providing electrical continuity between the bare cell coupling portion and corresponding first and second circuit board coupling portions, the diagonals forming acute included angles with corresponding area of the first and second circuit board coupling portions.
